(19) United States
(12) Patent Application Publication
(10) Pub. No.: US 2023/0367630 A1
(43) Pub. Date: Nov. 16, 2023

(54) STREAM MULTIPLEPROCESSOR, GPU, AND RELATED METHOD

(71) Applicant: ALIBABA (CHINA) CO., LTD., ZHEJIANG PROVINCE (CN)

(72) Inventors: HAORAN LI, SHANGHAI (CN); FEI SUN, SAN JOSE, CA (US); YUAN GAO, SHANGHAI (CN)

(21) Appl. No.: 18/055,205

(22) Filed: Nov. 14, 2022

(30) Foreign Application Priority Data
May 13, 2022 (CN) 202210521992.7

(51) Int. Cl. G06F 9/48; G06F 9/52; G06F 1/20

(52) U.S. Cl. CPC G06F 9/4875; G06F 9/52; G06F 1/20

(57) ABSTRACT

A stream multiprocessor, a GPU, and related methods are provided. The stream multiprocessor executes thread blocks. Each thread block includes warps. The stream multiprocessor includes stream processors and a local dispatcher. Each stream processor executes one or more warps. The local dispatcher includes a warp state table, a warp resource detection unit and a warp launching unit. The warp state table records dispatching states and processing states of warps of the thread blocks. The warp resource detection unit selects all the first warps of a first thread block and at least one second warp of a second thread block according to hardware resources available to the stream multiprocessor and hardware resources required for thread blocks. The warp launching unit dispatches the first warps to idle stream processors and at least one second warp to at least one idle stream processor.

### CROSS-REFERENCE TO RELATED APPLICATIONS

This application claims priority of China application No. 202210521992.7, filed on May 13, 2022, which is incorporated by reference in its entirety.

### BACKGROUND OF THE PRESENT DISCLOSURE

### Field of the Present Disclosure

The present disclosure relates to a stream multiprocessor and, more particularly, to a stream multiprocessor capable of parallel processing thread blocks of different kernels to enhance computation efficiency.

### Description of the Prior Art

Graphics processing units (GPUs) are capable of parallel computing and thus are not only applicable to drawing 3D images but also applicable to speeding up AI model or big data analysis which requires plenty parallel computing. In general, GPUs each comprise a a plurality of stream multiprocessors (SM). Each stream multiprocessor comprises a plurality of stream processors (SP). The parallel computing entails assigning each stream multiprocessor to execute one or more thread blocks of one kernel code, with each thread block comprising a plurality of warps. In this situation, the GPU usually takes a warp as an execution unit and assigns stream processors in the stream multiprocessor to execute threads in a warp, then threads in another warp (if any), and so forth.

To enhance computation efficiency, some GPUs allow their stream multiprocessors to simultaneously execute thread blocks of different kernel codes. However, since each thread block includes a plurality of warps, and warps of different kernels may compete for hardware resource of a same type, it is difficult to schedule the warps and effectively increase the hardware utilization rate of the GPUs. Therefore, how to schedule the stream processors in the stream multiprocessor in a way to enhance overall computation efficiency remains an issue to be solved.

### SUMMARY OF THE PRESENT DISCLOSURE

It is an objective of the disclosure to provide a stream multiprocessor, a GPU, and related methods to solve the aforementioned issues.

One embodiment of the disclosure provides a stream multiprocessor, for executing a plurality of thread blocks with each of the thread blocks comprising a plurality of warps. The stream multiprocessor comprises a plurality of stream processors and a local dispatcher. The local dispatcher comprises a warp state table, a warp resource detection unit, and a warp launching unit. The warp state table is configured to record a dispatching state and a processing state of each of the warps of the thread blocks. The warp resource detection unit is configured to select all first warps of a first thread block and at least one second warp of a second thread block from the thread blocks according to hardware resources available to the stream multiprocessor and hardware resources required for the thread blocks. The warp launching unit is configured to dispatch the first warps to first stream processors idling among the stream processors and dispatch the at least one second warp to at least one second stream processor idling among the stream processors.

Another embodiment of the present disclosure discloses a GPU. The GPU comprises a plurality of stream multiprocessors aforementioned, and a global thread block dispatcher for dispatching thread blocks in a plurality of kernels received by the GPU to the stream multiprocessors.

Another embodiment of the present disclosure discloses a method of operating a stream multiprocessor. The stream multiprocessor comprises a plurality of stream processors and a local dispatcher. The method comprises: receiving a plurality of thread blocks by the stream multiprocessor, wherein each of the thread blocks comprises a plurality of warps; recording an dispatching state and a processing state of each of the warps of the thread blocks in the local dispatcher; selecting, by the local dispatcher, all warps of a first thread block from the thread blocks according to hardware resources available to the stream multiprocessor and hardware resources required for the thread blocks; dispatching, by the local dispatcher, the first warps to first stream processors idling among the stream processors; selecting, by the local dispatcher, at least one second warp of a second thread block from the thread blocks according to hardware resources available to the stream multiprocessor and hardware resources required for the thread blocks; and dispatching, by the local dispatcher, the at least one second warp to at least one second stream processor idling among the stream processors.

Another embodiment of the present disclosure discloses a method of operating a GPU. The method comprises: receiving a plurality of kernels by the GPU; dispatching a thread block of a first kernel in the kernels to a stream multiprocessor in the GPU by the GPU according to hardware resources required for the kernels, thereby allowing the stream multiprocessor to execute the method of claim 12; and dispatching a thread block of a second kernel consecutively to the first stream multiprocessor, wherein hardware resources required for the second kernel and hardware resources required for the first kernel are complementary.

### BRIEF DESCRIPTION OF THE DRAWINGS

FIG. 1 is a schematic view of a stream multiprocessor according to one embodiment of the disclosure.

FIG. 2 is a schematic view of a local dispatcher for dispatching kernels and thread blocks thereof according to one embodiment of the disclosure.

FIG. 3 is a flowchart of a thread block dispatching method according to one embodiment of the disclosure.

FIG. 4 is a schematic view of a warp state table according to one embodiment of the disclosure.

FIG. 5 is a schematic view of a graphics processing unit (GPU) according to one embodiment of the disclosure.

### DETAILED DESCRIPTION OF THE EMBODIMENTS

The following disclosure provides various different embodiments or examples for implementing different features of the present disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various embodiments. This repetition is for the purpose of simplicity and clarity and does not in itself dictate a relationship between the various embodiments and/or configurations discussed.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “generally” means within an acceptable standard error of the mean when considered by one of ordinary skill in the art. As could be appreciated, other than in the operating/working examples, or unless otherwise expressly specified, all of the numerical ranges, amounts, values, and percentages (such as those for quantities of materials, duration of times, temperatures, operating conditions, portions of amounts, and the likes) disclosed herein should be understood as modified in all instances by the term “generally.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Here, ranges can be expressed herein as from one endpoint to another endpoint or between two endpoints. All ranges disclosed herein are inclusive of the endpoints, unless specified otherwise.

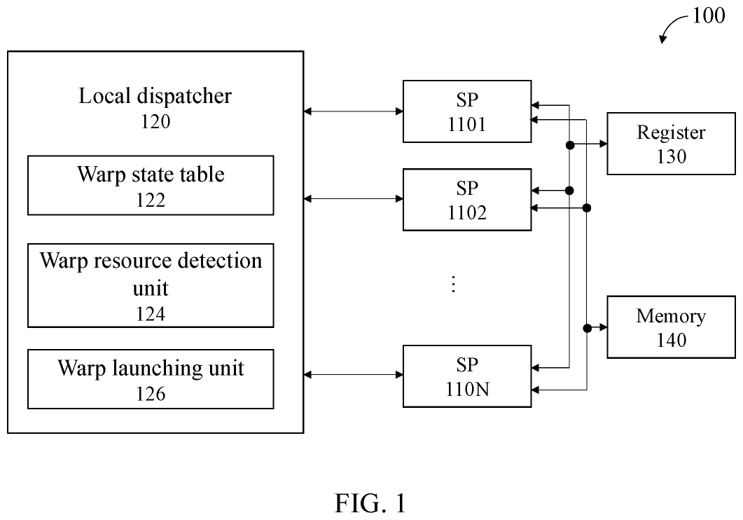

FIG. 1 is a schematic view of a stream multiprocessor (SM) 100 according to one embodiment of the disclosure. The SM 100 comprises N stream processors (SP) 1101 to 110N and a local dispatcher 120, where N is an integer greater than 1; in some embodiments, N can be, for example but not limited to, 128.

The SM 100 receives a plurality of kernels. Each of the kernels comprises a plurality of thread blocks. Each of the thread blocks comprises a plurality of warps. In general, threads in a same warp are corresponding to the same instructions, and thus the local dispatcher 120 can dispatch one warp of threads at a time, so that each warp can be dispatched to a stream processor for execution. The SM 100 further comprises hardware resources which are shared by the stream processors 1101 to 110N. For instance, the SM 100 comprises a register 130 and a memory 140, and the stream processors 1101 to 110N can use the register 130 and the memory 140 to store data required for computation or generated in the course of computation. The required hardware resources vary from warp to warp, and thus the local dispatcher 120 has to dispatch appropriate warps to the idle stream processors according to the hardware resources currently available to the SM 100.

In the present embodiment, the local dispatcher 120 comprises a warp state table 122, a warp resource detection unit 124 and a warp launching unit 126. The warp state table 122 can record a dispatching state and a processing state of each warp in each thread block received by the SM 100. The warp resource detection unit 124 can select executable warps in the thread blocks according to the records in the warp state table 122 and the hardware resources available to the SM 100, and the warp launching unit 126 can dispatch the selected warps to the idle stream processors to execute the selected warps.

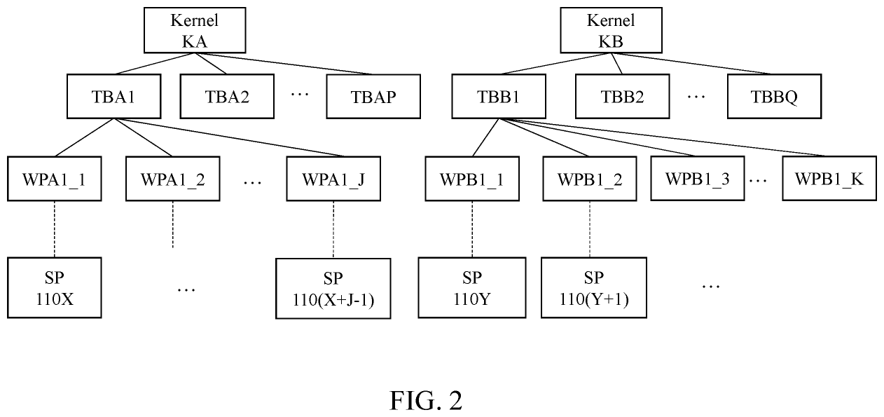

FIG. 2 is a schematic view of the local dispatcher 120 for dispatching kernels KA, KB and thread blocks thereof according to one embodiment of the disclosure. As shown in FIG. 2, the thread blocks to be dispatched by the local dispatcher 120 comprise P thread blocks TBA1 to TBAP in the kernel KA and Q thread blocks TBB1 to TBBQ in the kernel KB. Each thread block comprises a plurality of warps. For instance, thread block TBA1 comprises J warps WPA1_1 to WPA1_J, and thread block TBB1 comprises K warps WPB1_1 to WPB1_K. In the present embodiment, P, Q, K and J are integers greater than 1.

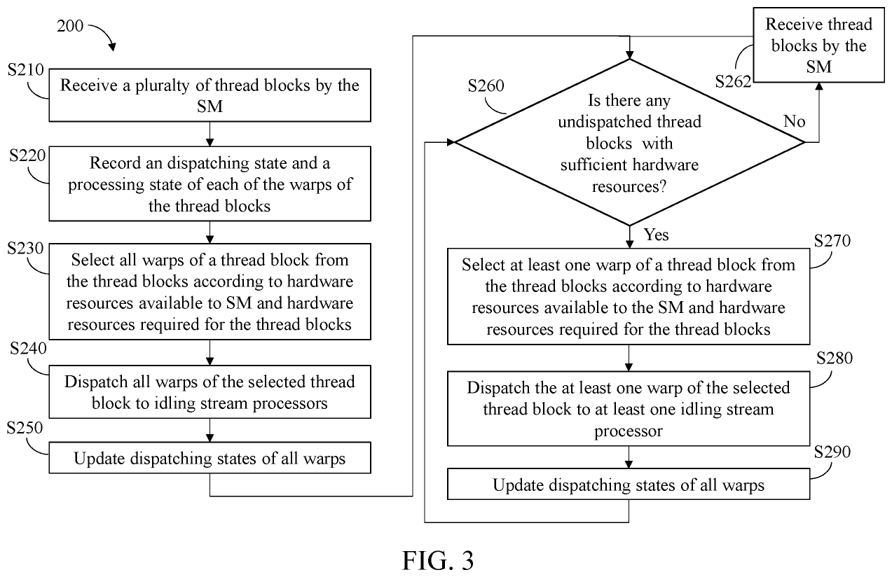

FIG. 3 is a flowchart of a thread block dispatching method 200 according to one embodiment of the disclosure. In the present embodiment, the method 200 comprises steps S210 to S290, and the local dispatcher 120 can dispatch the thread blocks TBA1 to TBAP and TBB1 to TBBQ illustrated in FIG. 2 according to the method 200.

In step S210, the SM 100 receives thread blocks TBA1 to TBAP of the kernel KA and thread blocks TBB1 to TBBQ of the kernel KB. In step S220, the local dispatcher 120 records a dispatching state and a processing state of each warp in each thread block. For instance, all warps in thread blocks TBA1 to TBAP and TBB1 to TBBQ are in an undispatched state when the SM 100 receives thread blocks TBA1 to TBAP and TBB1 to TBBQ, and thus the local dispatcher 120 can record in the warp state table 122 that all the warps of thread blocks TBA1 to TBAP and TBB1 to TBBQ are in an “undispatched” state.

In step S230, the local dispatcher 120 selects all warps of a thread block from thread blocks TBA1 to TBAP and TBB1 to TBBQ according to hardware resources available to the SM 100 and hardware resources required for each thread block. For instance, the local dispatcher 120 selects warps WPA1_1 to WPA1_J in the first thread block TBA1 from thread blocks TBA1 to TBAP and TBB1 to TBBQ. In step S240, the warp launching unit 126 dispatches warps WPA1_1 to WPA1_J to the idle stream processors (for example, stream processors 110X to 110 (X+J−1), where X denotes a positive integer, and X+J−1 is less than N) among stream processors 1101 to 110N. In some embodiments, the SM 100 is disposed in a GPU, and a global thread block dispatcher of the GPU can record the hardware resources required for the warps of the thread blocks of all the kernels received by the GPU; thus, when the global thread block dispatcher dispatches the kernel KA to the SM 100, messages pertaining to the hardware resources required for each thread block and warps thereof are also sent to the SM 100, thereby allowing the local dispatcher 120 of the SM 100 to dispatch the warps according to the hardware resources required for each thread block and warps thereof; however, the disclosure is not limited thereto. In some other embodiments, the local dispatcher 120 may independently determine the hardware resources required for the warps of the received thread blocks according to the contents of the received thread blocks.

After warps WPA1_1 to WPA1_J have been dispatched to the stream processors correspondingly, the local dispatcher 120 can updates the dispatching state of warps WPA1_1 to WPA1_J in the warp state table 122 from “undispatched” to “dispatched” in step S250.

In step S250, the local dispatcher 120 further records the processing state of warps WPA1_1 to WPA1_J in stream processors 110X to 110 (X+J−1). For instance, in some embodiments, each warp has therein a synchronization point, such that when execution of the warps by the stream processors reaches the synchronization point, the stream processors have to wait until all the other warps in the same thread block have been executed to reach their synchronization points, in order to continue performing the subsequent computation of each warp. Thus, if the warp WPA1_1 is executed quickly and thereby is the earliest one to reach the synchronization point, the stream processor processing the warp WPA1_1 will stall the execution of the warp WPA1_1 and wait until all the other warps WPA1_2 to WPA1_J in the thread block TBA1 have been executed to reach their synchronization points, in order for the stream processors to continue performing the subsequent computation of the warp WPA1_1. In such case, the local dispatcher 120 can further record the processing state of the warps WPA1_1 to WPA1_J to be “stalled-at-sync” (awaiting synchronization) or “not stalled” according to the processing status of the warps WPA1_1 to WPA1_J by the stream processors 110X to 110 (X+J−1). Namely, the local dispatcher 120 can record the processing state of a warp to be “stalled-at-sync” when the warp is executed to reach its synchronization point and the stream processors have to await the other warps, and the local dispatcher 120 can record the processing state of the warp to be “not stalled” when the warp is being executed by the stream processors.

After the warps WPA1_1 to WPA1_J have been dispatched to the stream processors 110X to 110 (X+J−1) for execution, the local dispatcher 120 can perform step S260 to confirm whether the SM 100 still has thread blocks to be dispatched. In the present embodiment, since the thread blocks TBA2 to TBAP and TBB1 to TBBQ have not yet been dispatched, the local dispatcher 120 can select warps in at least one thread block and dispatch the selected warps to the idle stream processors for processing if there are sufficient hardware resources.

In some embodiments, thread blocks in the same kernel may need hardware resources of the same type, and thus the SM 100 may not have sufficient hardware resources to execute the thread block TBA2 in the kernel KA while the thread block TBA1 in the kernel KA is being executed. In such case, the SM 100 may give priority to selecting the thread blocks TBB1 to TBBQ in the kernel KB that is different from the kernel KA associated with the thread block TBA1. Furthermore, to ensure that the SM 100 can effectively execute the selected thread blocks, the local dispatcher 120 may also determine whether the SM 100 still has sufficient available hardware resources.

For instance, if the thread block TBA1 has to occupy 30% of the capacity of the register 130 in the SM 100, and the thread block TBB1 has to occupy 80% of the capacity of the register 130 in the SM 100, the SM 100 can only begin to execute the thread block TBB1 after the execution of the thread block TBA1 is completed and the otherwise-used capacity of the register 130 is released, under the principle that all warps in a thread block must be dispatched together at a time. It is because when the SM 100 executes the thread block TBA1, the remaining 70% capacity of the register 130 of the SM 100 is not sufficient for the execution of the thread block TBB1. In the present embodiment, however, the SM 100 allows the local dispatcher 120 to dispatch one warp at a time. Thus, in step S270, although the hardware resources available to the SM 100 are not sufficient to execute all the warps of the thread block TBB1 after the thread block TBA1 has been dispatched, the local dispatcher 120 may still select some warps from the thread block TBB1 according to the hardware resources available to the SM 100 and the hardware resources required for the thread block TBB1 if the hardware resources available to the SM 100 are still sufficient to execute some of the warps in the thread block TBB1. For example, at least one warp, such as the warps WPB1_1 and WPB1_2, among the warps WPB1_1 to WPB1_K may be selected.

Then, in step S280, the warp launching unit 120 can dispatch some of the warps WPB1_1 and WPB1_2 in the thread block TBB1 to the idle ones of the stream processors 1101 to 110N, for example, stream processors 110Y and 110 (Y+1), where Y denotes a positive integer, and Y+1 is less than or equal to N. In such case, a period in which the stream processors 110X to 110 (X+J−1) execute the warps WPA1_1 to WPA1_J would overlap with a period in which the stream processors 110Y and 110 (Y+1) execute of the warps WPB1_1 and WPB1_2. That is, the SM 100 can execute all the warps in the thread block TBA1 and some of the warps in the thread block TBB1 in parallel, thereby improving the hardware utilization rate and overall computation performance of the SM 100.

After the warps WPB1_1 and WPB1_2 have been dispatched to the corresponding stream processors, the warp launching unit 120 can update the dispatching states of the warps WPB1_1 and WPB1_2 in the warp state table 122 from “undispatched” to “dispatched” in step S290. Furthermore, like the description of step S250, in step S290, the local dispatcher 120 can also record the processing state as “stalled-at-sync” or “not stalled” according to the processing status of the warps WPB1_1 and WPB1_2 in the stream processors 110Y and 110 (Y+1).

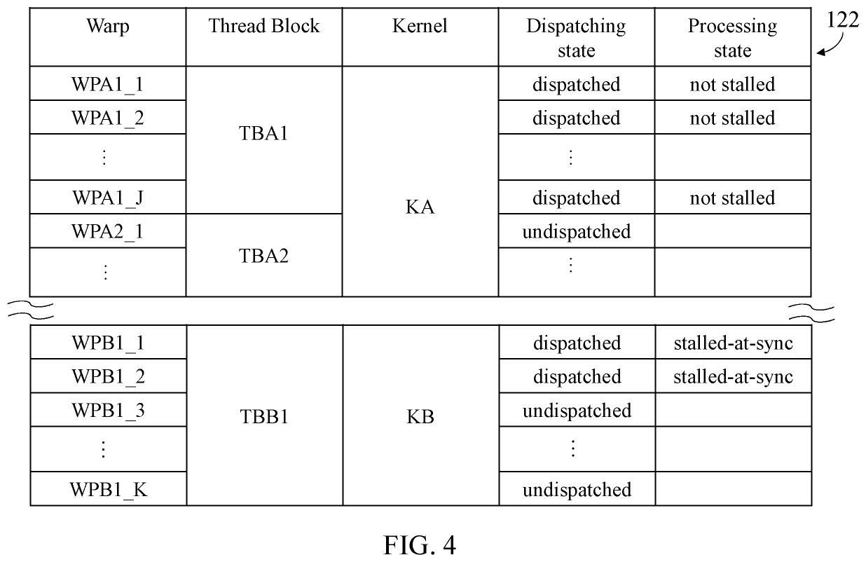

FIG. 4 is a schematic view of the warp state table 122 according to one embodiment of the disclosure. In the present embodiment, for the sake of illustration, the kernels, thread blocks, and warps are denoted by symbols and numerals in FIG. 4. In some embodiments, however, the kernels, thread blocks and warps may be described in any other appropriate or convenient ways, such as numeral numbering. Likewise, states, such as “dispatched,” “undispatched,” “not stalled” and “stalled-at-sync,” stated in the warp state table 122 may also be presented in numerals, Boolean symbols or other forms of denotations.

As shown in FIG. 4, in the present embodiment, only some of the warps WPB1_1 to WPB1_2 in the thread block TBB1 are in the “dispatched” state, but the other warps in the thread block TBB1 are still in the “undispatched” state. In such case, when the stream processors 110Y and 110 (Y+1) execute the warps WPB1_1 to WPB1_2 to reach their synchronization points, the execution of warps WPB1_1 to WPB1_2 will stall; after the other warps in the thread block TBB1 are dispatched and executed to reach their synchronization points, the warps WPB1_1 to WPB1_2 will stop awaiting and finish the subsequent computation. That is, it is possible that the warps WPB1_1 to WPB1_2 may stay in the “stalled-at-sync” state for a long period of time, and during this state, the stream processors 110Y and 110 (Y+1) for executing the warps WPB1_1 to WPB1_2 are in a stall state characterized by cessation of computation, thereby reducing the hardware utilization rate and computation performance of the SM 100.

In the present embodiment, to increase the hardware utilization rate and computation performance of the SM 100, when the execution of the warps WPB1_1 to WPB1_2 stays in the processing state of awaiting synchronization (“stalled-at-sync”), after a predetermined period, the stream processors 110Y and 110 (Y+1) can temporarily store existing computation data of the warps WPB1_1 to WPB1_2 in the memory, for example, the memory inside the stream processors 110Y and 110 (Y+1) or the memory 140 in the SM 100, and perform the warp switching operation. That is, the stream processors 110Y and 110 (Y+1) are regarded as idle stream processors again. Therefore, the warp launching unit 120 may dispatch undispatched warps in the thread blocks to the stream processors 110Y and 110 (Y+1) to reduce the awaiting time of the stream processors, so as to increase the hardware utilization rate and computation performance of the SM 100.

In the present embodiment, the stream processors 1101 to 110N each comprise a warp scheduler. The warp scheduler can continuously track other warps corresponding to the temporarily-stored warps and check if the other warps have reached their synchronization points. When all the warps corresponding to the same thread block reach their synchronization points, the stream processors can read the temporarily-stored data of the warps WPB1_1 to WPB1_2 from the memory and continue with subsequent computation of the warps WPB1_1 to WPB1_2.

In addition, to shorten the duration in which the warps WPB1_1 to WPB1_2 are in the “stalled-at-sync” processing state for increasing the hardware utilization rate and computation performance of the SM 100, if the SM 100 has sufficient available hardware resources and some warps in the warp state table 122 are still in the “stalled-at-sync” processing state, the warp resource detection unit 124 may give priority to selecting from thread blocks at least one warp in a thread block having the greatest number of warps in the “stalled-at-sync” state and dispatching the at least one warp selected to idling ones of the stream processors, such that all warps in the thread blocks can be executed to reach their synchronization points as soon as possible.

For instance, as shown in FIG. 4, although the dispatching states of the warps WPB1_1 and WPB1_2 of the thread block TBB1 are “dispatched,” the dispatching states of some other warps, such as the warps WPB1_3 to WPB1_K, of the thread block TBB1 are “undispatched.” In such case, when the warps WPB1_1 and WPB1_2 are executed to reach their synchronization points, the warps WPB1_1 and WPB1_2 enter the processing state “stalled-at-sync”, and the execution of the warps WPB1_1 and WPB1_2 cannot be resumed until the other warps, for example, the undispatched warps WPB1_3 to WPB1_K, in the thread block TBB1 have to be dispatched and executed to reach their synchronization points. Therefore, at this point in time, to avoid overly long awaiting duration of the warps WPB1_1 and WPB1_2, even if the SM 100 receives new kernels, the local dispatcher 120 will, given sufficient hardware resources available to the SM 100, give priority to selecting the warps WPB1_3 to WPB1_K which are in the same thread block TBB1 as the warps WPB1_1 and WPB1_2 and dispatching the selected warps WPB1_3 to WPB1_K to the idle stream processors for processing, and will dispatch the thread blocks of the other kernels only after all the warps WPB1_1 to WPB1_K of the thread block TBB1 have been dispatched.

If all warps in a thread block have been dispatched to the stream processors, then all the warps in the thread block can be executed to reach their synchronization points, and thus the duration in which each warp is in the “stalled-at-sync” state is rather short. In some embodiments, to shorten the duration in which each warp is in the “stalled-at-sync” state, if the hardware resources available to the SM 100 are sufficient to provide the hardware resources required for all the warps in the thread block TBB1, the local dispatcher 120 will give priority to selecting all the warps WPB1_1 to WPB1_K in the thread block TBB1 in step S270 and dispatching the warps WPB1_1 to WPB1_K to the idle stream processors for execution in step S280. Thus, the duration in which the warps WPB1_1 to WPB1_K are in the “stalled-at-sync” state can be shortened, thereby improving the computation performance of the SM 100. That is, given sufficient hardware resources available to the SM 100, the local dispatcher 120 may select all warps in a thread block to shorten the duration in which the warps are in the “stalled-at-sync” state, thereby improving the hardware utilization rate and computation performance of the SM 100.

In the present embodiment, steps S260 to S290 can be performed repeatedly. In step S260, if undispatched thread blocks no longer exist in the SM 100, or if hardware resources available to the SM 100 are no longer sufficient, the process flow of the method will go to step S262, so as to await the receipt of a new thread block by the SM 100 or await the release of hardware resources which are otherwise taken up.

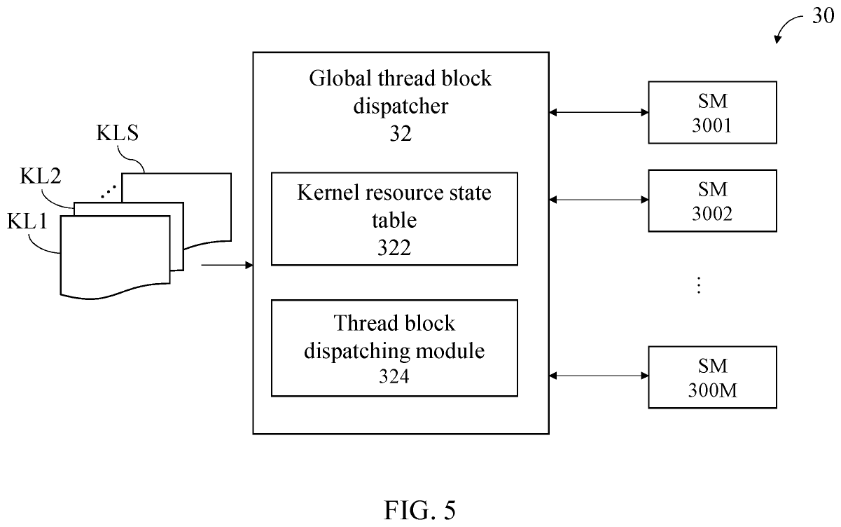

FIG. 5 is a schematic view of a graphics processing unit (GPU) 30 according to one embodiment of the disclosure. The GPU 30 comprises M SMs 3001 to 300M and a global thread block dispatcher 32, where M denotes an integer greater than 1. In the present embodiment, the GPU 30 is, for example, disposed in an electronic device, such as a notebook computer or a mobile device. The CPU (central processing unit) of the electronic device may dispatch kernels to the GPU 30 execution. As shown in FIG. 5, the GPU 30 may receive S kernels KL1 to KLS, where S denotes an integer greater than 1, and the global thread block dispatcher 32 dispatches thread blocks to the SMs 3001 to 300M according to the kernels KL1 to KLS. In the present embodiment, for example, the SMs 3001 to 300M each can have the same structure as the SM 100 and can operate by the same principle as the SM 100.

The global thread block dispatcher 32 comprises a kernel resource state table 322 and a thread block dispatching module 324. The kernel resource state table 322 records hardware resources required for the kernels KL1 to KLS. That is, the global thread block dispatcher 32 can record the hardware resources required for thread blocks and warps in the kernels KL1 to KLS, for example, the required register capacity and memory capacity, in the kernel resource state table 322.

The thread block dispatching module 324 dispatches thread blocks of the kernels KL1 to KLS to the SMs 3001 to 300M according to the kernel resource state table 322. In the present embodiment, the SMs 3001 to 300M can each use its local dispatcher to dispatch warps or thread blocks of kernels to the stream processors, respectively; therefore, the thread block dispatching module 324 may continuously dispatches thread blocks of the kernels KL1 to KLS to the SMs 3001 to 300M, regardless of whether the hardware resources currently available to the SMs 3001 to 300M are sufficient to execute the kernels to be dispatched.

In some embodiments, to increase the efficiency of execution of the kernels KL1 to KLS by the GPU 30, the thread block dispatching module 324 can dispatch the kernels whose execution requires complementary hardware resources to the same stream multiprocessor, so that the chance that the stream multiprocessor can simultaneously execute thread blocks of different kernels can be increased. For instance, if the kernel KL1 needs much register capacity but few shared memory capacity while the kernel KL2 needs much shared memory capacity but few register capacity, then because the major hardware resources required for the kernels KL1 and KL2 are also different, the chance of competition between the kernels KL1 and KL2 for hardware resources of the same type should be rather low; therefore, the hardware resources required for the kernels KL1 and KL2 can be deemed complementary. In such case, after the thread block dispatching module 324 has dispatched thread blocks of the kernel KL1 to the SM 3001, the thread block dispatching module 324 may further give priority to dispatching thread blocks of the kernel KL2 to the SM 3001 consecutively. Thus, the chance of simultaneous execution of thread blocks of the two different kernels KL1 and KL2 by the SM 3001 can be increased, thereby improving the hardware utilization rate of the SM 3001 and the overall computation performance of the GPU 30.

In conclusion, the stream multiprocessor, GPU, and related methods provided by the embodiments of the present disclosure allow the local dispatcher in the stream multiprocessor to dispatching tasks in the manner of warp by warp, so as to render the dispatching process flexible, increase the chance for the stream multiprocessor to process warps of different thread blocks in parallel, thereby improving the hardware utilization rate and computation performance of the stream multiprocessor.

The foregoing description briefly sets forth the features of certain embodiments of the present application so that persons having ordinary skill in the art more fully understand the various aspects of the disclosure of the present application. It will be apparent to those having ordinary skill in the art that they can easily use the disclosure of the present application as a basis for designing or modifying other processes and structures to achieve the same purposes and/or benefits as the embodiments herein. It should be understood by those having ordinary skill in the art that these equivalent implementations still fall within the spirit and scope of the disclosure of the present application and that they may be subject to various variations, substitutions, and alterations without departing from the spirit and scope of the present disclosure.

What is claimed is:

1. A stream multiprocessor, for executing a plurality of thread blocks, each of the thread blocks comprising a plurality of warps, the stream multiprocessor comprising:
a plurality of stream processors; and
a local dispatcher comprising:
a warp state table configured to record a dispatching state and a processing state of each of the warps of the thread blocks;
a warp resource detection unit configured to select all first warps of a first thread block and at least one second warp of a second thread block from the thread blocks according to hardware resources available to the stream multiprocessor and hardware resources required for the thread blocks; and
a warp launching unit configured to dispatch the first warps to first stream processors idling among the stream processors and dispatch the at least one second warp to at least one second stream processor idling among the stream processors.

2. The stream multiprocessor of claim 1, wherein a period in which the first stream processors execute the first warps overlaps with a period in which the at least one second stream processor executes the at least one second warp.

3. The stream multiprocessor of claim 1, wherein:
the first warps are corresponding to a first kernel, and the at least one second warp is corresponding to a second kernel;
after the first warps have been dispatched to the first stream processors, the warp resource detection unit selects the at least one second warp of the second thread block when the hardware resources available to the stream multiprocessor are insufficient to execute all warps of the second thread block but sufficient to execute the at least one second warp of the second thread block.

4. The stream multiprocessor of claim 1, wherein, after the warp launching unit has dispatched the first warps to the first stream processors and dispatched the at least one second warp to the at least one second stream processor, the warp resource detection unit updates dispatching states of the first warps and the at least one second warp in the warp state table as being dispatched.

5. The stream multiprocessor of claim 1, wherein, after the warp resource detection unit has selected all the first warps in the first thread block, the warp resource detection unit gives priority to selecting and dispatching all warps of the second thread block to idling ones of the stream processors when the stream multiprocessor still has sufficient available hardware resources.

6. The stream multiprocessor of claim 1, wherein, when execution of the at least one second warp by the at least one second stream processor reaches a synchronization point, but execution of at least one warp other than the at least one second warp in the second thread block has not reached the synchronization point, the at least one second stream processor stops processing the at least one second warp, and the warp resource detection unit updates a processing state of the at least one second warp in the warp state table as awaiting synchronization.

7. The stream multiprocessor of claim 6, wherein, when the execution of the at least one second warp stays in the processing state of awaiting synchronization after a predetermined period, the at least one second stream processor temporarily stores existing computation data of the at least one second warp and performs warp switching to switch to execution of at least one other warp.

8. The stream multiprocessor of claim 1, wherein, when the stream multiprocessor has sufficient available hardware resources, and processing states of some warps in the warp state table are “awaiting synchronization”, the warp resource detection unit gives priority to selecting from the thread blocks at least one warp in a thread block having the greatest number of warps in the processing state of awaiting synchronization and dispatching the at least one warp selected to idling ones of the stream processors.

9. A GPU, comprising:
a plurality of stream multiprocessors of claim 1; and
a global thread block dispatcher for dispatching thread blocks in a plurality of kernels received by the GPU to the stream multiprocessors.

10. The GPU of claim 9, wherein the global thread block dispatcher comprises:
a kernel resource state table for recording hardware resources required for the kernels; and
a thread block dispatching module for dispatching the thread blocks of the kernels to the stream multiprocessors according to the kernel resource state table.

11. The GPU of claim 10, wherein, after the thread block dispatching module has dispatched a thread block of a first kernel in the kernels to a first stream multiprocessor of the stream multiprocessors, the thread block dispatching module gives priority to dispatching a thread block of a second kernel of the kernels consecutively to the first stream multiprocessor, wherein hardware resources required for the second kernel and hardware resources required for the first kernel are complementary.

12. A method of operating a stream multiprocessor, the stream multiprocessor comprising a plurality of stream processors and a local dispatcher, the method comprising:
receiving a plurality of thread blocks by the stream multiprocessor, wherein each of the thread blocks comprises a plurality of warps;
recording an dispatching state and a processing state of each of the warps of the thread blocks in the local dispatcher;
selecting, by the local dispatcher, all warps of a first thread block from the thread blocks according to hardware resources available to the stream multiprocessor and hardware resources required for the thread blocks;
dispatching, by the local dispatcher, the first warps to first stream processors idling among the stream processors;
selecting, by the local dispatcher, at least one second warp of a second thread block from the thread blocks according to hardware resources available to the stream multiprocessor and hardware resources required for the thread blocks; and
dispatching, by the local dispatcher, the at least one second warp to at least one second stream processor idling among the stream processors.

13. The method of claim 12, wherein a period in which the first stream processors execute the first warps overlaps with a period in which the at least one second stream processor executes the at least one second warp.

14. The method of claim 12, wherein the first warps are corresponding to a first kernel, and the at least one second warp is corresponding to a second kernel, wherein the step of selecting by the local dispatcher the at least one second warp of the second thread block from the thread blocks according to hardware resources available to the stream multiprocessor and hardware resources required for the thread blocks comprises selecting, by the local dispatcher, the at least one second warp of the second thread block after the first warps have been dispatched to the first stream processors and when the hardware resources available to the stream multiprocessor are insufficient to execute all warps of the second thread block but sufficient to execute the at least one second warp of the second thread block.

15. The method of claim 12, further comprising:
updating dispatching states of the first warps as being dispatched after the local dispatcher has dispatched the first warps to the first stream processors; and
updating a dispatching state of the at least one second warp as being dispatched after the local dispatcher has dispatched the at least one second warp to the at least one second stream processor.

16. The method of claim 12, wherein the step of selecting by the local dispatcher the at least one warp of the second thread block from the thread blocks according to hardware resources available to the stream multiprocessor and hardware resources required for the thread blocks comprises selecting all warps of the second thread block when the stream multiprocessor has sufficient available hardware resources.

17. The method of claim 12, further comprising:
stopping processing the at least one second warp by the at least one second stream processor when execution of the at least one second warp by the at least one second stream processor reaches a synchronization point, but execution of at least one warp other than the at least one second warp in the second thread block has not reached the synchronization point; and
updating, by the local dispatcher, the processing state of the at least one second warp as awaiting synchronization.

18. The method of claim 17, further comprising:
storing existing computation data of the at least one second warp temporarily by the at least one second stream processor when the execution of the at least one second warp stays in the processing state of awaiting synchronization after a predetermined period; and
performing warp switching to switch to execution of at least one other warp by the at least one second stream processor.

19. The method of claim 18, further comprising:
when the stream multiprocessor has sufficient available hardware resources, and processing states of some warps are awaiting synchronization, giving, by the local dispatcher, priority to selecting from the thread blocks at least one warp in a thread block having the greatest number of warps in the processing state of awaiting synchronization state to dispatch the at least one warp selected to idling ones of the stream processors.

20. A method of operating a GPU, further comprising:
receiving, by a GPU, a plurality of kernels;
dispatching, by the GPU, the a thread block of a first kernel in the kernels to a stream multiprocessor in the GPU according to hardware resources required for the kernels, thereby allowing the stream multiprocessor to execute the method of claim 12; and
dispatching a thread block of a second kernel consecutively to the first stream multiprocessor, wherein hardware resources required for the second kernel and hardware resources required for the first kernel are complementary.
